(19) United States
(12) Patent Application Publication
(10) Pub. No.: US 2014/0020218 A1
(43) Pub. Date: Jan. 23, 2014

(54) Strap Binder Handle Formed by Board Material and Forming Method Thereof

(71) Applicant: Jung-Wen Lu, Taichung City (TW)

(72) Inventor: Jung-Wen Lu, Taichung City (TW)

(21) Appl. No.: 13/551,282

(22) Filed: Jul. 17, 2012

(51) Int. Cl. B65H 77/00; B23P 11/00

(52) U.S. Cl. 24/68 CD; 29/428

(57) ABSTRACT

In a strap binder handle formed by a plate material and its forming method, a pull handle between two side plates of a handle is integrally coupled to a connecting portion and a grip, and the two side plates and the grip are bent and formed, and a stop plate is hardened and installed, and two slide portions of the stop plate are disposed into two slide slot respectively, and the connecting portion is bent into an opening formed on a side of the stop plate and towards a side of the grip having the stop portion, and an elastic element is installed between the stop plate and the pull handle.

### FIELD OF THE INVENTION

The present invention relates to a strap binder handle, in particular to the strap binder handle formed by a board material and a forming method thereof.

### BACKGROUND OF THE INVENTION

With reference to FIG. 12 for a conventional strap binder, a reel 82 is coupled between a base 80 and a handle 81, and the handle 81 includes two side plates 810, wherein the two side plates 810 are coupled to an end away from the reel 82 by a grip 811, and an end proximate to the reel 82 is coupled by a shaft rod 812, so that an interval between the two side plates 810 is fixed, and when the handle 81 is flipped, the reel 82 is driven to rotate. The grip 811 and the shaft rod 812 are pivotally coupled to the two side plates 810, such that the strap binder can become a portable device. However, the strap binder may be hit by other objects or dropped on the floor, such that the handle 81 of the strap binder may be cracked or broken at the riveting position of the grip 811 or the shaft rod 812 with the two side plates 810, and the interval between the two side plates 810 cannot be fixed any more, and the handle 81 fails to drive the reel 82 to rotate.

R.O.C. Utility Model Pat. No. 230504 discloses an integrally formed operating arm 10 formed by bending a long-strip plate 15, and a pair of parallel support arms can be manufactured. A plate 16 with a relatively wider width is installed at the middle of the long-strip plate 15 can be used to form a circular handle. However, when the two support arms are formed, only the circular handle is integrally coupled. Although the circular handle and the two support arms come with a better connecting strength, the operating arm 10 as shown in FIG. 13 still requires a shaft rod A to be pivotally coupled to an end away from the circular handle to set a constant interval of the two support arms, so that the pivoting position of the shaft rod and the two support arms still may be hit by an object or dropped onto the floor to result in a crack or a breakage, so that the combining strength of the structure still requires improvements.

### SUMMARY OF THE INVENTION

Therefore, it is a primary objective of the present invention to provide a strap binder handle formed by a plate material and a forming method thereof, wherein a handlebar and a connecting portion are integrally coupled to two side plates, so that the handle has a good structural strength, and if the strap binder is hit by an object or dropped onto the floor, the pivotally coupled handle will not break or crack like the conventional strap binder, and the present invention can provide a relatively more secured structure.

To achieve the foregoing objective, the present invention provides a strap binder handle comprising:

a pull handle, having two parallel side plates, a sheathing portion disposed at an end of each side plate and sheathed on a reel of the strap binder separately, and each side plate having a slide slot being a rectangular hole penetrating through the side plate, and the slide slot formed on the side plate being proximate to sheathing portion, a handlebar being integrally coupled between the two side plates and at a position away from an end of the sheathing portion, and a connecting portion being integrally coupled between the two side plates and disposed at corresponding positions of the slide slot, and the two side plates having a slant surface section formed at a middle-section position separately, and the two slant surface sections being retracted towards an interval at an end of the two sheathing portions, and the two slant surface sections being expanded towards an interval at an end of the handlebar, and the slide slot of each side plate being extended into the slant surface section;

a stop plate, integrally formed, and having an opening to form a pull handle, and two slide portions protruded outwardly further in a lateral side than the pull handle, and the two slide slots cut into an interval of the two slant surface sections being greater than the width between the two slide portions, and the stop plate at the positions of the two slant surface sections of the two slide portions being placed in a direction towards the sheathing portion into two slide slots, and the two slide portions being protruded out of the two slide slots, and the connecting portion having a stop portion bent towards a side of the handlebar and into the opening formed on the side of the handlebar, and an elastic element installed between the stop plate and the pull handle for elastically bouncing and restoring the stop plate to its original position.

To achieve the aforementioned objective, the present invention further provides a strap binder handle forming method, comprising the following steps:

Pre-cutting: Pre-cut at least one plate material into a predetermined shape of the pull handle and the stop plate, wherein the two side plates of the pull handle, the connecting portion and the handlebar are in a flat plate shape;

Forming a slant surface section: after the pull handle is pre-cut, the two side plates are bent to form the slant surface sections respectively;

Bending two side plates: after the slant surface sections of the pull handle are formed, the two side plates on both sides of the connecting portion are bent in the same direction and parallel to each other;

Hardening: Harden the pull handle and the stop plate by a thermal treatment after the slant surface sections are formed and the two side plates are bent; and

Assembling and Forming: after the pull handle and the stop plate are hardened, the stop plate is installed into the slide slot of the two side plates of the pull handle, and the elastic element is installed, and then the stop portion is bent into the opening of the stop plate for limiting the stop plate into the slide slot.

### BRIEF DESCRIPTION OF THE DRAWINGS

FIG. 1 is a perspective view of a strap binder in accordance with a first preferred embodiment of the present invention;

FIG. 2 is a perspective view of a handle in accordance with the first preferred embodiment of the present invention;

FIG. 3 is a schematic view of an area for pre-cutting a pull handle and a stop plate from a plate material in accordance with the first preferred embodiment of the present invention;

FIG. 4 is a flow chart of forming a strap binder handle in accordance with the first preferred embodiment of the present invention;

FIG. 5 is a schematic view of a pull handle pre-cut and formed from a plate material in accordance with the first preferred embodiment of the present invention;

FIG. 6 is a schematic view of a slant surface section bent from a pull handle in accordance with the first preferred embodiment of the present invention;

FIG. 7 is a schematic view of side plates on both sides of a pull handle being bent towards a same direction in accordance with the first preferred embodiment of the present invention;

FIG. 8 is a schematic view of a formed structure of a strap binder handle in accordance with the first preferred embodiment of the present invention;

FIG. 9 is a perspective view of a strap binder in accordance with a second preferred embodiment of the present invention;

FIG. 10 is a schematic view of a slide block disposed in a pull handle in accordance with the second preferred embodiment of the present invention;

FIG. 11 is a schematic view of a pull handle and a slide block pivotally coupled in a pull handle in accordance with the second preferred embodiment of the present invention;

FIG. 12 is a perspective view of a conventional strap binder; and

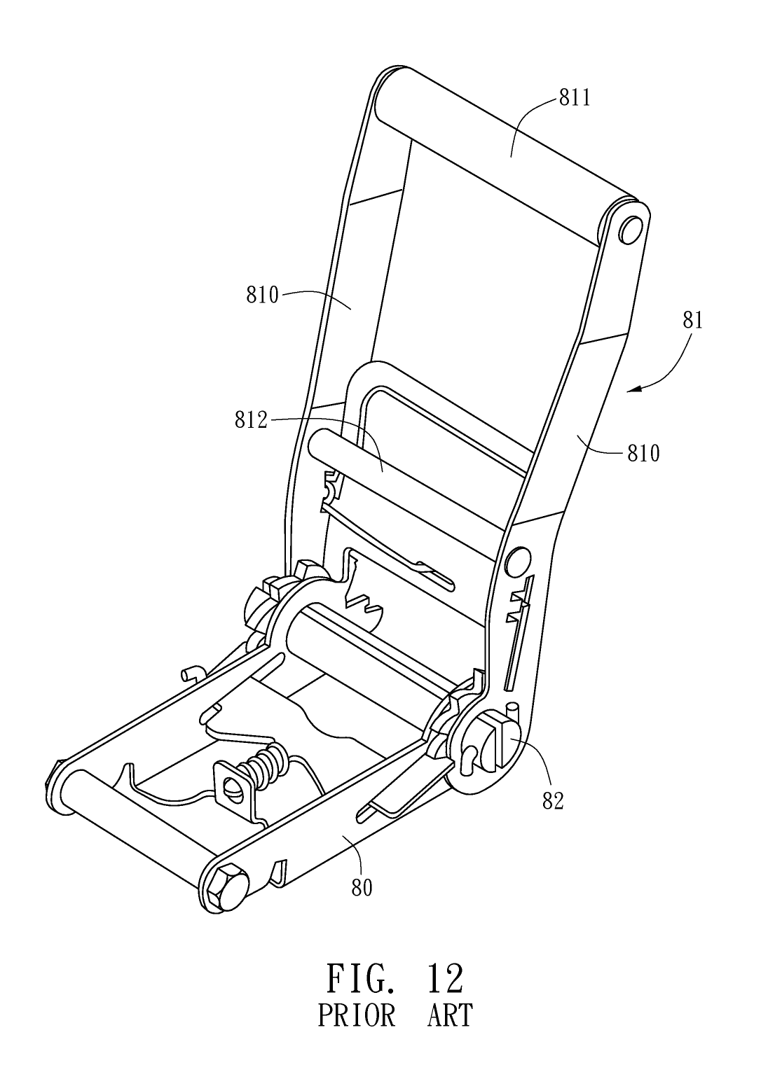

FIG. 13 is a schematic view of an operating arm combined with a shaft rod as disclosed in R.O.C. Utility Model Pat. No. 230504.

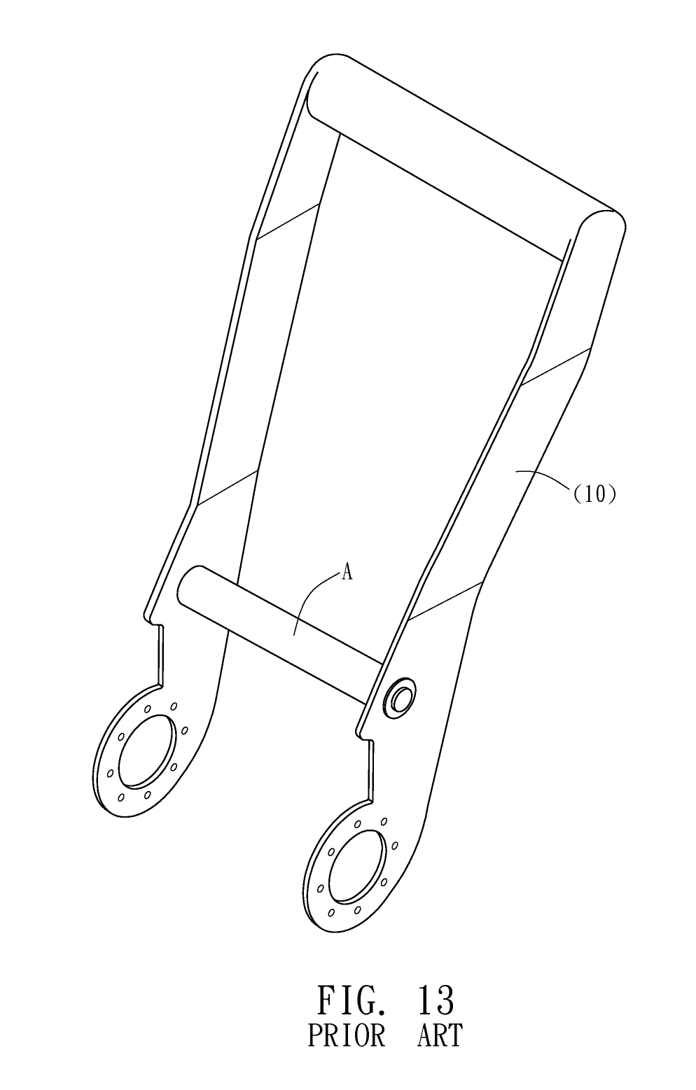

### DESCRIPTION OF THE PREFERRED EMBODIMENTS

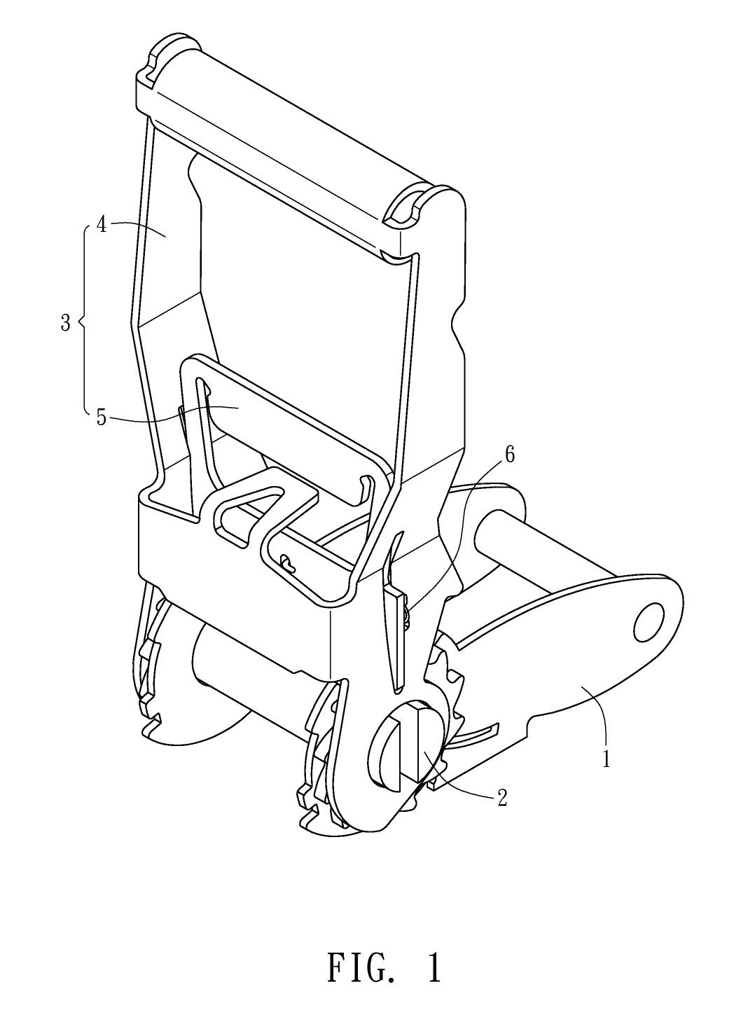

With reference to FIGS. 1 to 8 for a binder handle formed by a plate material and a forming method of the present invention, the following preferred embodiments are used for the purpose of illustrating the present invention, but not intended for limiting the scope of the present invention.

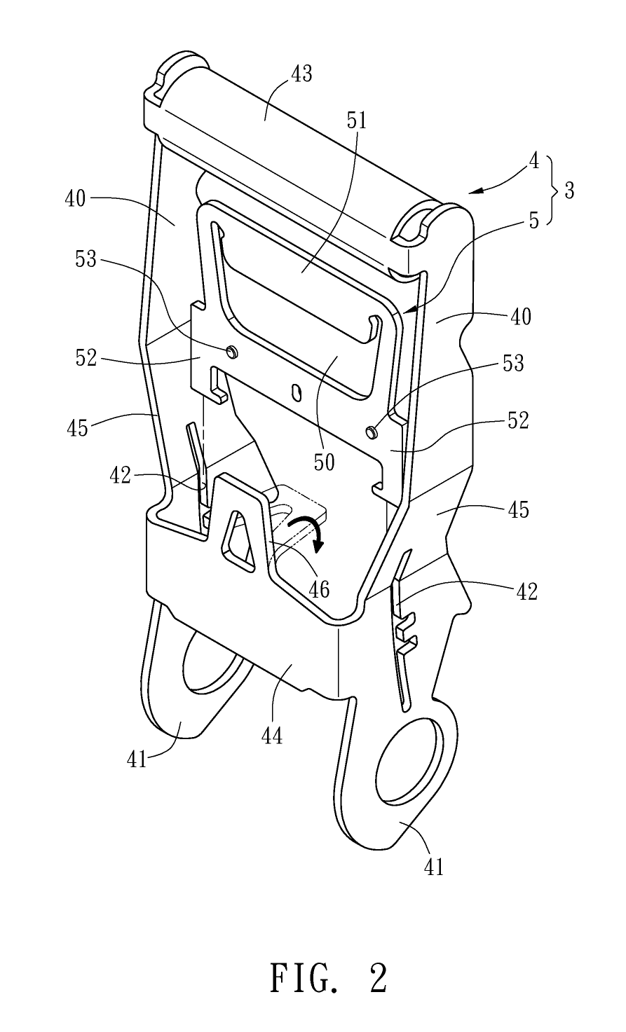

This preferred embodiment provides a strap binder handle formed by a plate material as shown in FIG. 1, the strap binder comprises a base 1, a reel 2 and a handle 3 as shown in FIGS. 1 and 2, and the handle 3 of this preferred embodiment comprises a pull handle 4 and a stop plate 5.

In FIG. 2, the pull handle 4 has two side plates 40 parallel to each other, and a sheathing portion 41 disposed at an end of each side plate 40 and sheathed on the reel 2. Each side plate 40 has a slide slot 42 which is a rectangular hole penetrating through the side plate 40, and the slide slot 42 is formed on the side plate 40 proximate to the sheathing portion 41, and a handlebar 43 is integrally coupled between the two side plates 40 and disposed at a position away from an end of the sheathing portion 41, and a connecting portion 44 is integrally coupled between the two side plates 40 and disposed at corresponding positions of the slide slot 42, and the two side plates 40 have a slant surface section 45 formed at a middle-section position. The connecting portion 44 has a stop portion 46 arranged in a direction towards a side of the handlebar 43, and the two slant surface sections 45 are retracted in a direction towards an interval at an end of the two sheathing portions 41, and the two slant surface sections 45 are expanded in a direction towards an interval at an end of the handlebar 43, and the slide slot 42 of each side plate 40 is extended into the slant surface section 45.

In FIG. 2, the stop plate 5 is integrally formed with an opening 50 to form a pull handle 51 having two slide portions 52, and the two slide portions 52 are protruded outwardly further in the lateral direction than the pull handle 51, and the two slide slots 42 extended into the two slant surface sections 45 have an interval greater than the width of the two slide portions 52. In this preferred embodiment, the stop plate 5 has two protrusions 53 disposed on inner sides of the two side plates 40 and proximate to the side plates 40 respectively.

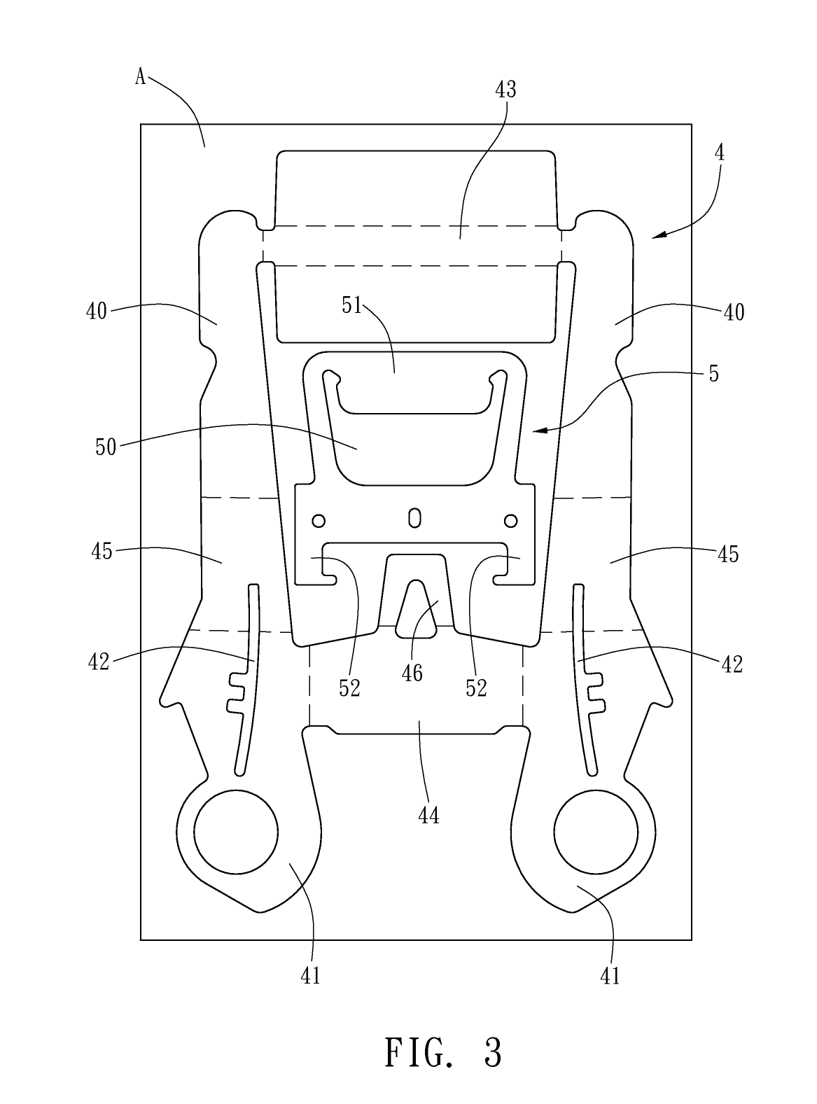

In FIG. 3, the stop plate 5 is placed in a direction towards the sheathing portion 41 into the two slide slots 42 by the two slide portions 52 at positions of the two slant surface sections 45, so that the two slide portions 52 are protruded from the two slide slots 42, and the stop portion 46 is bent into the opening 50, and the two protrusions 53 are used for limiting the stop plate 5 into the slide slot 42 of the two side plates 40.

In FIG. 1, an elastic element 6 is installed between the stop plate 5 and the pull handle 4, and the elastic element 6 of this preferred embodiment is a torque spring. If the elastic element 6 is pulled by the pull handle 4 and released, the stop plate 5 will bounce towards the reel 2 to resume its original position.

In FIG. 3, the pull handle 4 and the stop plate 5 are formed by the following processes. A plate element B is set within a predetermined area of the two side plates 40, the sheathing portion 41, the slide slot 42, the handlebar 43, the connecting portion 44, the slant surface section 45 and the stop portion 46 of the pull handle 4. The area of the plate element B between the two side plates 40, the handlebar 43 and the connecting portion 44 is large enough to form the stop plate 5, so that the pull handle 4 and the stop plate 5 can be cut from the plate element B, bent and formed, so as to achieve the effects of saving material and facilitating bending and forming the handle 3.

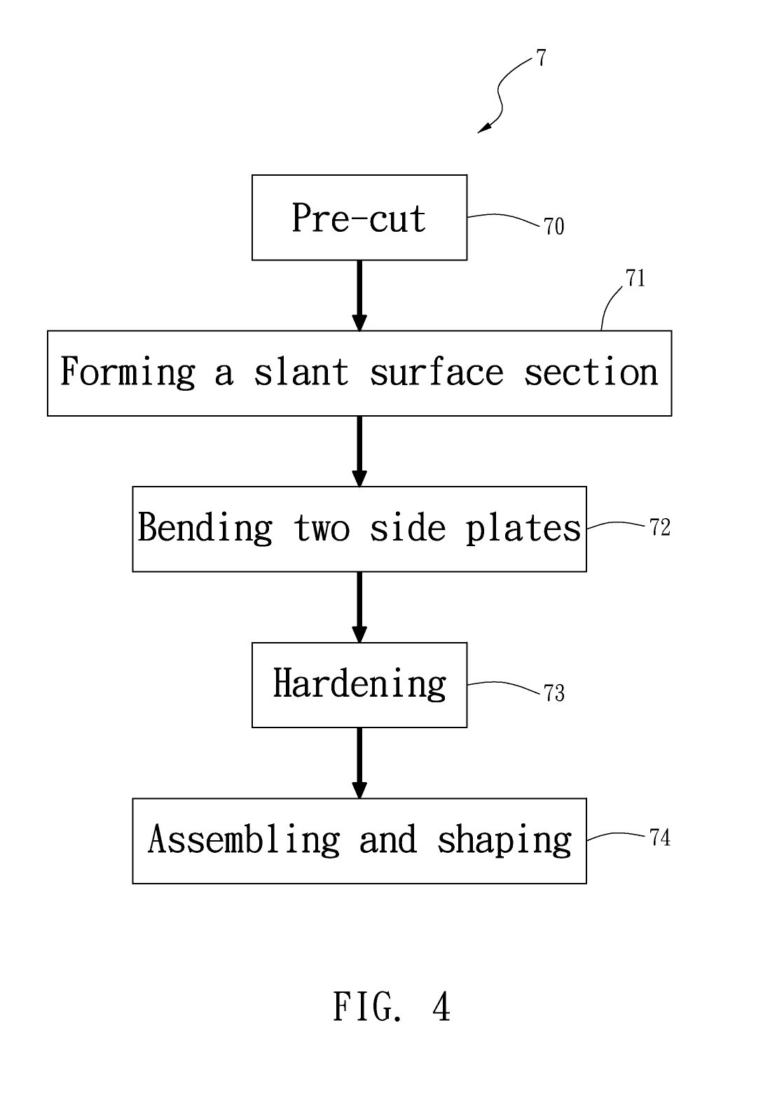

In FIG. 4, the strap binder handle forming method 7 in accordance with this preferred embodiment comprises the following steps: pre-cut 70, forming slant surface section 71, bending two side plates 72, hardening 73 and assembling and shaping 74.

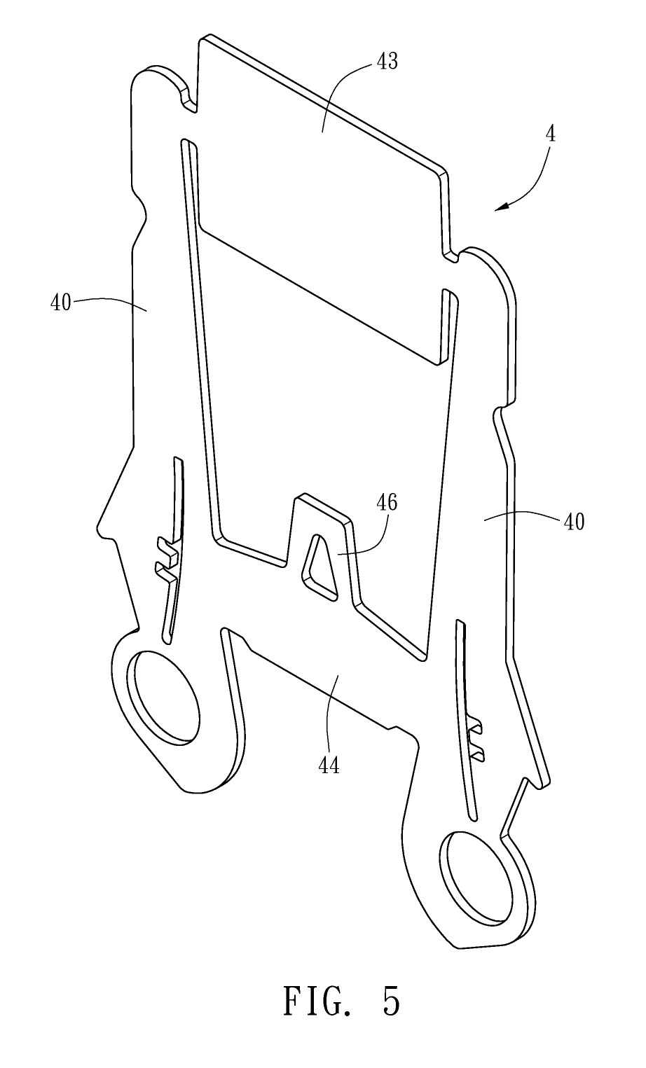

In the pre-cut 70 as shown in FIG. 5, the plate element B as shown in FIG. 3 is cut into a predetermined shape of the pull handle 4 and the stop plate 5. Now, the two side plates 40, the handlebar 43 and the connecting portion 44 of the pull handle 4 are in a flat plate shape.

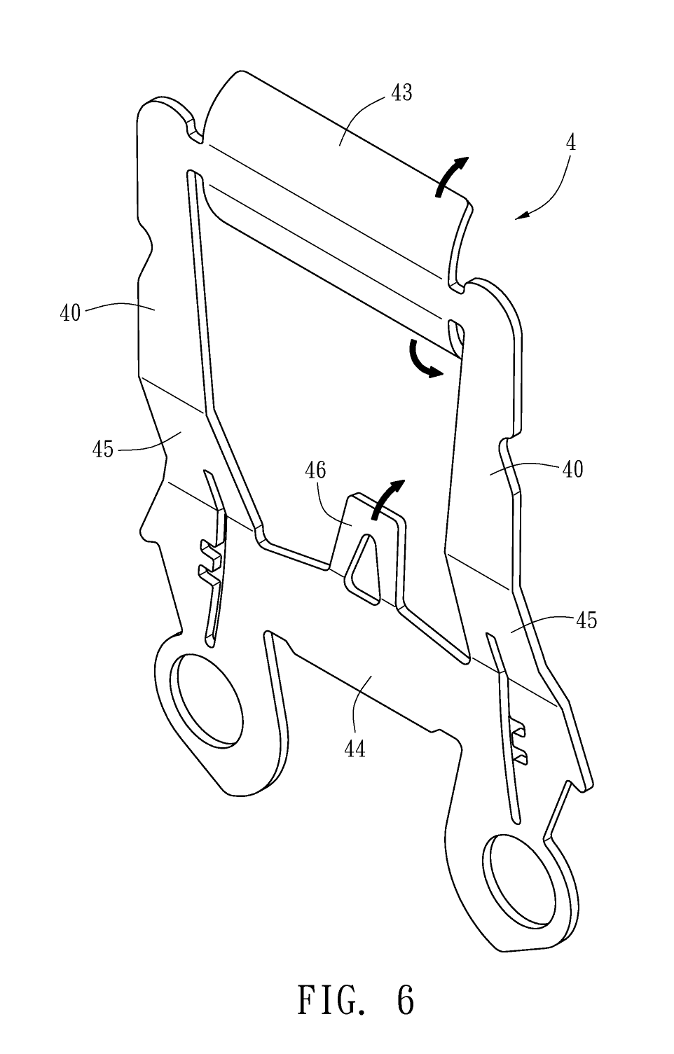

In the step of forming a slant surface section 71 as shown in FIG. 6, after the pull handle 4 is pre-cut, the two side plates 40 are bent to form each of the slant surface sections 45.

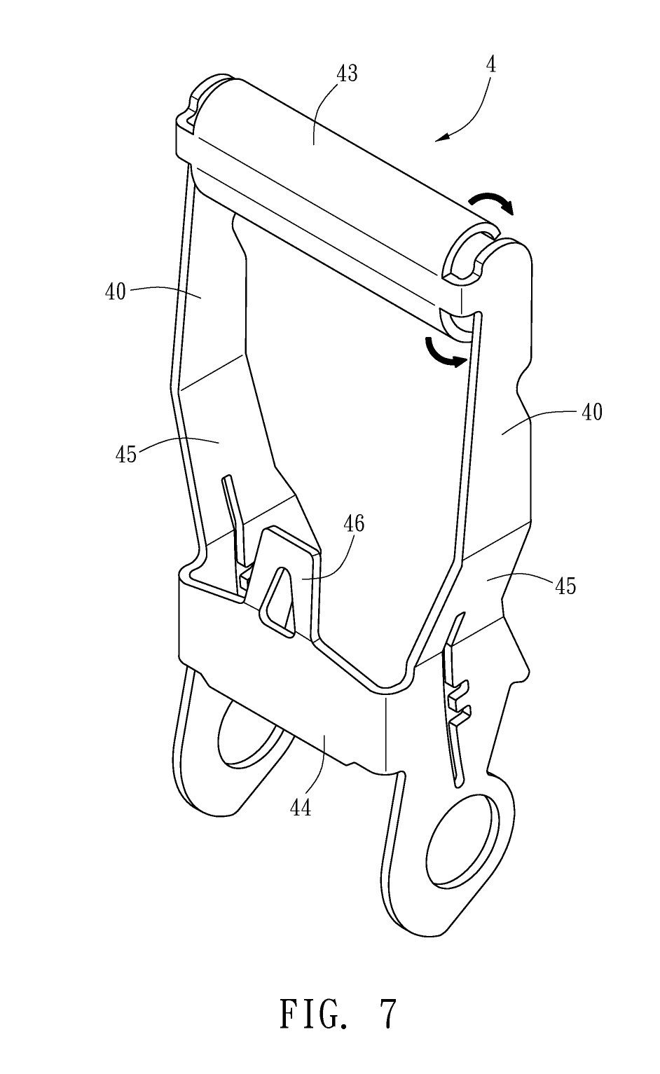

In the step of bending two side plates 72 as shown in FIG. 7, after the slant surface section 45 of the pull handle 4 is formed, the two side plates 40 on both sides of the connecting portion 44 are bent in the same direction and parallel to each other.

In the step of hardening 73, both of the pull handle 4 having the formed slant surface section 45 and the two bent side plates 40 and the stop plate 5 are hardened by a thermal treatment.

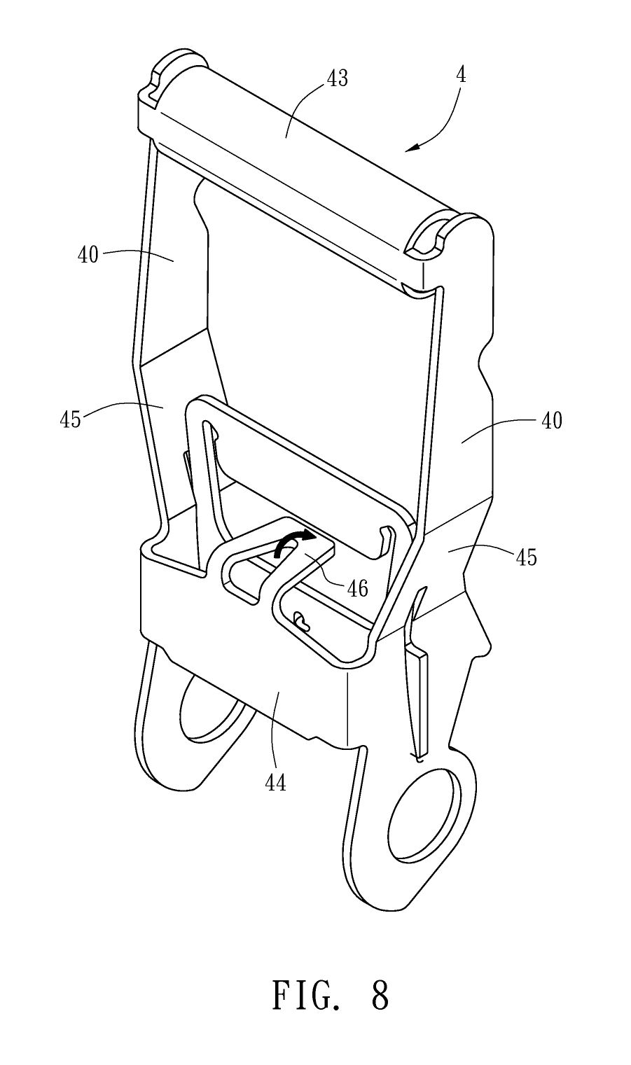

In the assembling and forming step 74 as shown in FIG. 8, after the pull handle 4 and the stop plate 5 are hardened, the stop plate 5 is placed into the slide slots 42 of the two side plates 40 of the pull handle 4, and the elastic element 6 is installed, and then the stop portion 46 is bent into the opening 50 of the stop plate 5 to limit the stop plate 5 into the slide slot 42.

In one of the steps of the pre-cut 70, forming a slant surface section 71 and bending two side plates 72, the stop portion 46 is bent towards the two side plates 40 in advance, so that the stop plate 5 can be placed into the slide slots 42 easily. In this preferred embodiment, the stop portion 46 as shown in FIG. 6 is bent in advance during the step of forming the slant surface section 71.

During the process of bending a flat plate into the handlebar 43, the handlebar 43 of this preferred embodiment is bent three times gradually, wherein the step of forming the slant surface section 71 as shown in FIG. 6 has bent the handlebar 43 for the first time, and the step of bending the two side plates 72 as shown in FIG. 7 has bent the handlebar 43 for the second time, and the step of hardening 73 has bent the handlebar 43 for the third time, so as to complete the bent handlebar 43 as shown in FIG. 8.

In summation of the description above, the present invention has the following advantages. The two side plates 40, the handlebar 43 and the connecting portion 44 of the pull handle 4 are integrally cut before bending and shaping, so that the two side plates 40 at an end of the handlebar 43 are integrally coupled to maintain an interval, and two side plates 40 at an end of the sheathing portion 41 are integrally coupled by the connecting portion 44 to maintain an interval. Compared with the conventional handle of the strap binder that requires a shaft rod for the riveting connection, the interval of the two side plates 40 of the present invention can be maintained constant by the integrally coupled handlebar 43 and connecting portion 44. Even if the strap binder is hit by other objects or dropped onto the floor, the riveting position will not cracked or broken as easily as the conventional handle. Therefore, the handle of the present invention has a more secured structural structure than the conventional handle.

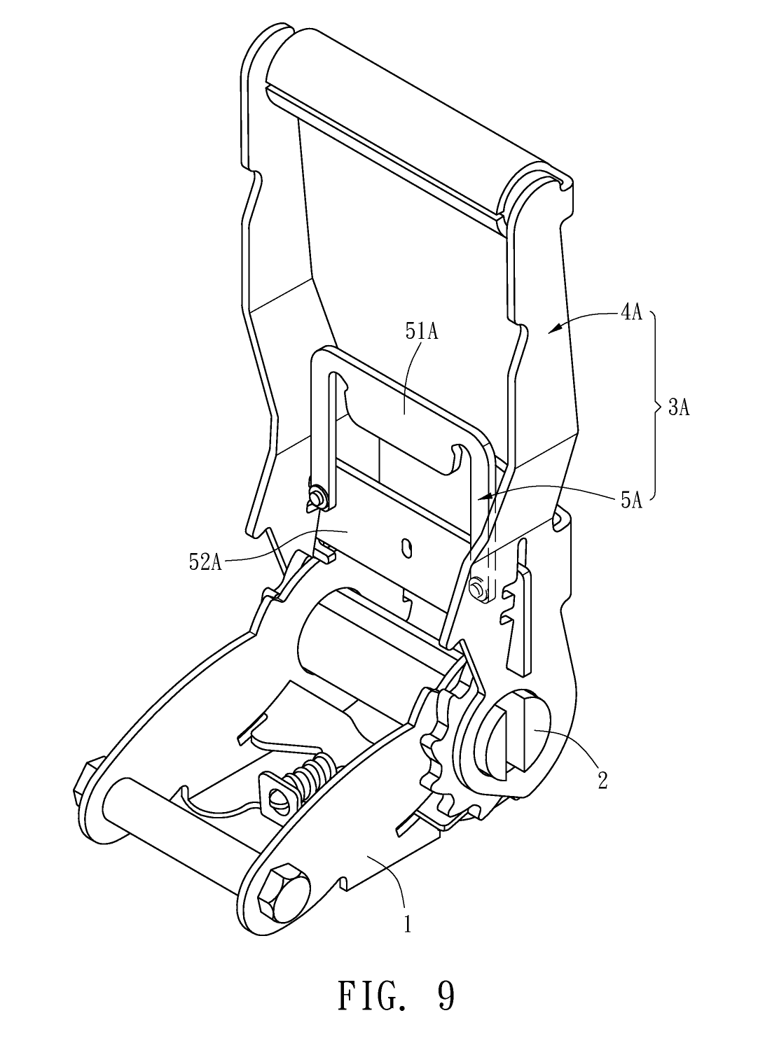

Of course, the present invention may have many other embodiments with minor changes with each other. With reference to FIGS. 9 to 11 for the second preferred embodiment of the present invention, the handle 3A comprises a pull handle 4A and a stop plate 5A, and the pull handle is the same as that of the first preferred embodiment and has the sheathing portion 41A sheathed on the reel 2 and combined with the base 1. The structure of the pull handle 4A is substantially the same as that of the first preferred embodiment and integrally coupled to the two side plates 40A, the handlebar 43A and the connecting portion 44A, except that the slide slot 42A of each side plate 40A is extended to a position proximate to the slant surface section 45A instead of being extended into the slant surface section 45 of the first preferred embodiment. The stop plate 5A of this preferred embodiment comprises a pull handle 51A and a slide block 52A, and the pull handle 51A has an opening 50A, and the slide block 52A has two slide portions 520A protruded further in the lateral direction than the pull handle 51A.

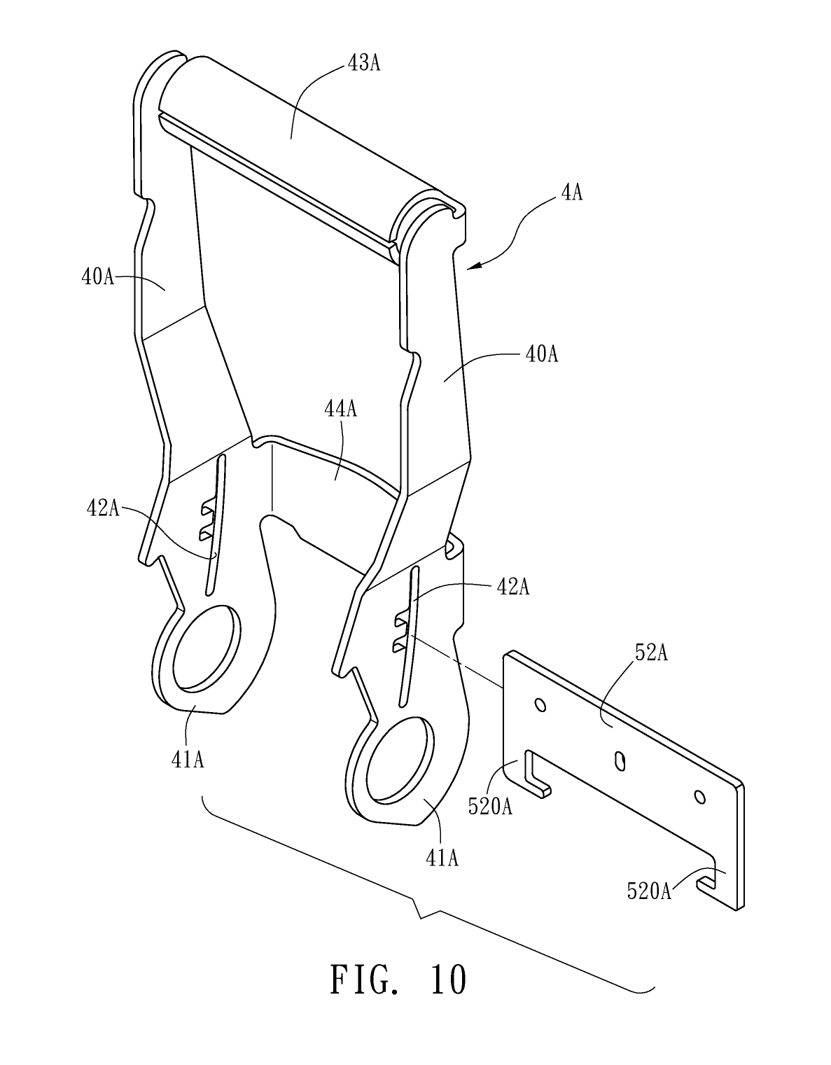

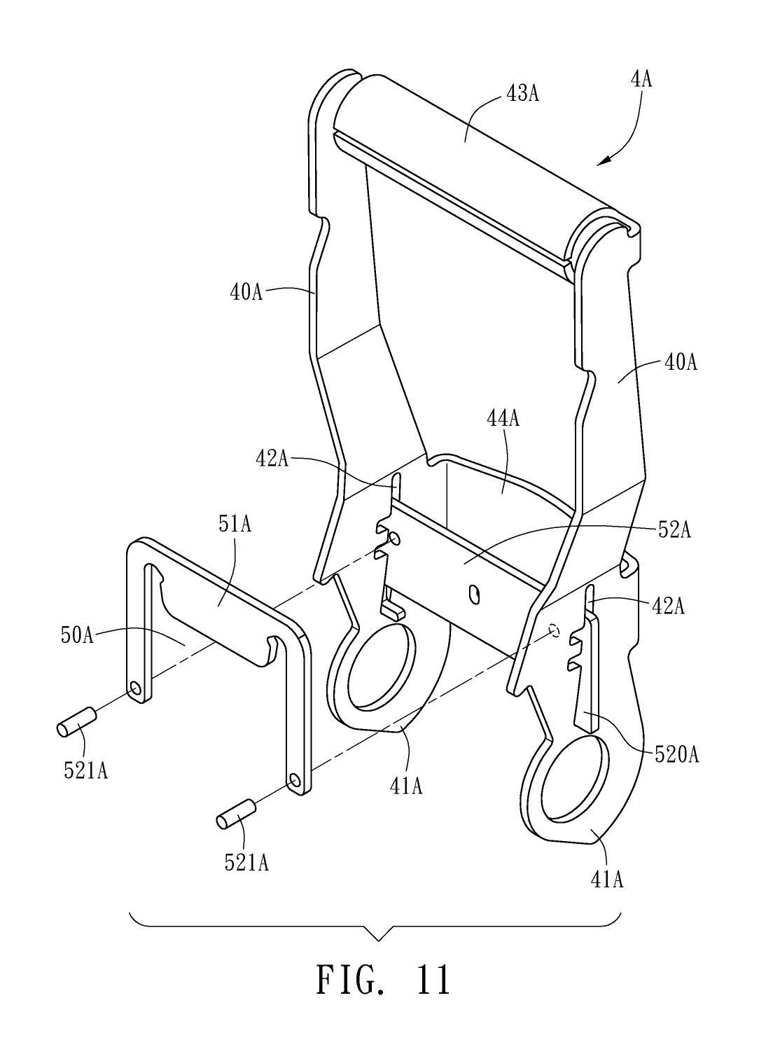

In FIG. 10, the slide block 52A of this preferred embodiment is placed into the two slide slots 42A from a side of the side plate 40A, and the two slide portions 520A are protruded out of the two slide slots 42A, and the pull handle 51A between the two side plates 40A is combined with the slide block 52A. In this preferred embodiment as shown in FIG. 11, the pull handle 51A and the slide block 52A are stacked with each other, and the pull handle 51A is pivotally coupled to the slide block 52A by a rivet 521A. Now, both sides of the pull handle 51A are blocked by inner sides of the two side plates 40A respectively to achieve the same effect of the protrusion 53 of the first preferred embodiment to limit the slide block 52A into the slide slot 42A of the two side plates 40A. Therefore, the handle 3A of this preferred embodiment also can achieve the same effects of the first preferred embodiment.

The forming method of the strap binder handle of this preferred embodiment is substantially the same as that of the first preferred embodiment, and the difference resides on that the slide slot 42A of each side plate 40A is extended to a position proximate to the slant surface section 45A, so that the connecting portion 44A of the pull handle 4A no longer requires the stop portion 46 adopted in the first preferred embodiment to limit the stop plate 5A into the slide slot 42A of the two side plates 40A. Therefore, this preferred embodiment can skip the steps of pre-cutting and bending the stop portion 46 as required in the first preferred embodiment.

What is claimed is:

1. A strap binder handle formed by a plate material, comprising:
a pull handle, having two parallel side plates, a sheathing portion disposed at an end of each side plate and sheathed on a reel of the strap binder separately, and each side plate having a slide slot being a rectangular hole penetrating through the side plate, and the slide slot formed on the side plate being proximate to sheathing portion, a handlebar being integrally coupled between the two side plates and disposed at a position away from an end of the sheathing portion, and a connecting portion being integrally coupled between the two side plates and disposed at corresponding positions of the slide slot, and the two side plates having a slant surface section formed at a middle-section position separately, and the two slant surface sections being retracted towards an interval at an end of the two sheathing portions, and the two slant surface sections being expanded towards an interval at an end of the handlebar, and the slide slot of each side plate being extended into the slant surface section; and
a stop plate, integrally formed, and having an opening to form a pull handle, and two slide portions protruded outwardly further in a lateral side than the pull handle, and the two slide slots cut into an interval of the two slant surface sections being greater than the width between the two slide portions, and the stop plate at the positions of the two slant surface sections of the two slide portions being placed in a direction towards the sheathing portion into two slide slots, and the two slide portions being protruded out of the two slide slots, and the connecting portion having a stop portion bent towards a side of the handlebar and into the opening formed on the side of the handlebar, and an elastic element installed between the stop plate and the pull handle for elastically bouncing and restoring the stop plate to its original position.

2. The strap binder handle formed by a plate material according to claim 1, wherein the stop plate has two protrusions for limiting the stop plate in the slide slots of the two side plates, and the two protrusions are disposed on inner sides of the two side plates and proximate to the side plates respectively.

3. A strap binder handle formed by a plate material, comprising:
a pull handle, having two parallel side plates, a sheathing portion disposed at an end of each side plate and sheathed onto a reel of the strap binder, a slide slot being a rectangular hole formed on the side plate and proximate to the sheathing portion and penetrating through the side plate, a handlebar integrally coupled between the two side plates and disposed at an end away from the sheathing portion, and a connecting portion integrally coupled between the two side plates and disposed at corresponding positions of the slide slot; and
a stop plate, including a pull handle with an opening, and a slide block, and the slide block having two opposite slide portions protruded further in a lateral direction towards the pull handle, and the slide block being placed from a side of the side plate into the two slide slots, and the two slide portions being protruded out of the two slide slots, and the pull handle being disposed between the two side plates being combined with the slide block, and an elastic element installed between the stop plate and the pull handle for elastically bouncing and restoring the stop plate to its original position.

4. The strap binder handle formed by a plate material according to claim 3, wherein the pull handle and the slide block are stacked with each other, and both sides of the pull handle are stopped by inner sides of two side plates respectively for limiting the slide block in the slide slots of the two side plates.

5. The strap binder handle formed by a plate material according to claim 3, wherein the two side plates have a slant surface section disposed at a middle-section position separately, and the two slant surface sections are retracted towards an interval at an end of the two sheathing portions, and the two slant surface sections are expanded outwardly towards an interval at an end of the handlebar, and the slide slot of each side plate being extended to a position proximate to the slant surface section.

6. A forming method of the strap binder handle according to claim 1, comprising the steps of:
pre-cutting at least one plate material into a predetermined shape of the pull handle and the stop plate, wherein the two side plates of the pull handle, the connecting portion and the handlebar are in a flat plate shape;
forming a slant surface section, wherein after the pull handle is pre-cut, the two side plates are bent to form the slant surface sections respectively;
bending two side plates, wherein after the slant surface sections of the pull handle are formed, the two side plates on both sides of the connecting portion are bent in the same direction and parallel to each other;
hardening the pull handle and the stop plate by a thermal treatment after the slant surface sections are formed and the two side plates are bent; and
assembling and forming after the pull handle and the stop plate are hardened, wherein the stop plate is installed into the slide slot of the two side plates of the pull handle, and the elastic element is installed, and then the stop portion is bent into the opening of the stop plate for limiting the stop plate into the slide slot.

7. The forming method of claim 6, wherein the stop portion is bent in a direction towards the two side plates in advance without hindering the stop plate to be installed into the slide slot in one of the steps of pre-cutting, forming the slant surface section and bending the two side plates.

8. The forming method of claim 6, wherein the handlebar is bent gradually for a plurality of times during the step of bending a flat plate into the handlebar, and the handlebar is bent synchronously once during the step of forming the slant surface sections, and the handlebar is bent synchronously once during the step of bending the two side plates.

9. The forming method of claim 6, wherein the pull handle and the stop plate are pre-cut and formed from the same plate material.

10. A forming method of the strap binder handle according to claim 3, comprising the steps of:
pre-cutting at least one plate material into a predetermined shape of the pull handle and the stop plate, wherein the two side plates of the pull handle, the connecting portion and the handlebar are in a flat plate shape;
pre-cutting at least one plate material into a predetermined shape of the pull handle and the stop plate, wherein the two side plates, the connecting portion and the handlebar of the pull handle are in a flat plate shape;
forming a slant surface section, wherein after the pull handle is pre-cut, the two side plates are bent to form the slant surface sections respectively;
bending two side plates, wherein after the slant surface sections of the pull handle are formed, the two side plates on both sides of the connecting portion are bent in the same direction and parallel to each other;
hardening the pull handle and the stop plate by a thermal treatment after the slant surface sections are formed and the two side plates are bent; and
assembling and forming after the pull handle and the stop plate are hardened, wherein the stop plate is installed into the slide slot of the side plate and limited into the slide slot, and the elastic element is installed.

11. The forming method of claim 10, wherein the handlebar is bent gradually for a plurality of times during the step of bending a flat plate into the handlebar, and the handlebar is bent synchronously once during the step of forming the slant surface sections, and the handlebar is bent synchronously once during the step of bending the two side plates.

12. The forming method of claim 10, wherein the pull handle and the stop plate are pre-cut and formed from the same plate material.
